(19) United States
(12) Patent Application Publication
(10) Pub. No.: US 2012/0111817 A1
(43) Pub. Date: May 10, 2012

(54) LOW-CLEARANCE RACK MOUNT ADAPTER

(75) Inventors: John Sweeny, Windham, NH (US); Tammy Soper, Wilmington, MA (US)

(73) Assignee: ALEXANDER MACHINE & TOOL COMPANY, INC., Woburn, MA (US)

(21) Appl. No.: 13/249,116

(22) Filed: Sep. 29, 2011

Related U.S. Application Data
(60) Provisional application No. 61/387,585, filed on Sep. 29, 2010.

(51) Int. Cl. A47B 23/00; B23P 11/00

(52) U.S. Cl. 211/133.6; 29/428; 29/525.01

(57) ABSTRACT

The invention relates to systems and processes for securably retaining a device within an equipment rack. A device carrier is configured to retain the device having a maximum height, such that a combined height of the device carrier and the device retained therein is not substantially greater than the maximum height of the device. A rack-mountable tray includes an aperture to accommodate the device carrier with a device retained therein. The device carrier is securable to the rack-mountable tray, such that the device retained therein can be securably retained to the equipment rack by a combination of the device carrier and the rack-mountable tray. Beneficially, a combined height of the device, the device carrier and the rack-mountable tray is not substantially greater than the maximum height of the device.

### RELATED APPLICATIONS

This application claims the benefit of U.S. Provisional Patent Application No. 61/387,585 entitled “Low-Clearance Rack Mount Adaptor,” filed on Sep. 29, 2010, and incorporated herein by reference in its entirety.

### BACKGROUND

Equipment designed to be placed in an electronic equipment rack is typically described as rack-mount, a rack-mount instrument, a rack mounted system, a rack mount chassis, a sub-rack, rack mountable, or occasionally simply a shelf. The height of the electronic modules adapted for rack mount is also standardized in a unit referred to as a standard rack unit or “U.” Presently, standard rack units are defined as multiples of 1.75 inches (4.445 cm). Such units are also widely used for computer server equipment, allowing for dense hardware configurations without occupying excessive floor space or requiring shelving.

Typically, a piece of equipment being installed in such an equipment rack has a front panel height that is somewhat less than an allotted number of rack units. For example, the front panel height is generally at least about 1/32-inch (0.031″) less than the allotted number of rack units. Thus, a 1U rack-mount computer is not 1.75 inches (44.4 mm) tall. Rather, the unit is about 1.719 inches (43.7 mm) tall. Similarly, a 2U rack-mount device would be about 3.469 inches (88.1 mm) instead of 2×1.75=3.5 inches (88.9 mm). Such a gap allows for some clearance that can be allocated above and below an installed piece of equipment. Such clearance in the overall height of a device is advantageous such that the device may be inserted and removed without binding on the adjacent equipment or upper and lower rack supports.

Many devices are designed with rack mounting in mind. Such devices typically include some sort of mounting flange or flanges to allow for direct mounting within a standardized equipment rack. Such flanges may extend laterally along a front panel of the device, positioned to abut vertical side rails of the equipment rack. The flanges may include holes and/or slots positioned for alignment with corresponding mounting holes/slots of the equipment rack. Fasteners can be used to attach the flanges to the equipment rack, thus securing the device at a desired height, in place within the rack.

Other devices are not specifically designed with features for direct rack mounting. Nevertheless, such devices are routinely mounted within such racks, using ancillary mounting hardware, such as a tray or shelf Quite often, such tray or shelf mounting is anticipated and such devices are provided with suitable heights to accommodate mounting according to standard rack units (i.e., allowing for the typical clearance, i.e., 1/32 inch, and additional clearance for a supporting shelf or tray, such as a thickness of a bottom shelf of such a shelf .

### SUMMARY

In one aspect, a low-clearance rack mounting adapter includes at least one device carrier. The device carrier includes an open frame having a horizontal support and at least one tray mounting flange. The device carrier also includes at least one device-mounting strap securably attached to the open frame. The at least one device-mounting strap and the horizontal support are configured to retain a device having a maximum height therebetween. Preferably, a combined height of the device retained within the device carrier is not substantially greater than the maximum height of the device. The rack mounting adapter also includes a rack-mountable tray defining at least one aperture configured accommodate the at least one device carrier. The rack-mountable tray also has at least one surface configured to accommodate the at least one tray mounting flange. Beneficially, the rack-mountable tray secures the device carrier and device retained therein with respect to an equipment rack without substantially adding to the maximum height of the device.

In another aspect, a process for securing a device within an equipment rack, includes positioning the device within an open frame of a device carrier, the device having a maximum height. The device is secured with respect to the device carrier, such that the combined height of the device and the device carrier is not substantially greater than the maximum height of the device. The device carrier with the device secured thereto, is secured to a rack-mounted tray. Beneficially a combined height of the device, the device carrier and the rack-mounted tray is not substantially greater than the maximum height of the device.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 illustrates an upper, front perspective view of an embodiment of a low-clearance, rack-mounting system.

FIG. 2A through FIG. 2C respectively illustrate a top, front and side views of an embodiment of a rack-mountable shelf

FIG. 3 illustrates an upper, front perspective view of an embodiment of a low-clearance, rack-mounting system.

FIG. 4 illustrates a front view of an example of a device mountable by a low-clearance, rack-mounting system.

FIG. 5 illustrates cantilever mounting of an example of a device within an embodiment of a device carrier that is, in turn, mountable by an embodiment of a low-clearance, rack-mounting system.

FIG. 6 illustrates an example of a device secured to an embodiment of a device carrier that is, in turn, mountable by a low-clearance, rack-mounting system.

FIG. 7A illustrates cantilever mounting of an example of a device within an embodiment of a device carrier

FIG. 7B illustrates insertion of the mounted device shown in FIG. 7A into an embodiment of a low-clearance, rack-mounting system.

FIG. 8 illustrates an upper perspective view of two example devices mounted within a low-clearance, rack-mounting system.

FIG. 9 illustrates a lower perspective view of a portion of the two example devices mounted within the low-clearance, rack-mounting system illustrated in FIG. 8.

### DETAILED DESCRIPTION

Unfortunately, in at least some instances, devices have an overall height that fails to meet acceptable clearance requirements when rack mounted with a separate shelf or tray. That is, the overall height of such devices is an integer number of standard rack units (e.g., 1U, 2U, . . . ), or slightly less than an integer number of standard rack units, but not less than acceptable clearance requirements (e.g., 1/32-inch (0.031″)) to prevent binding or interference when rack mounted on a shelf or tray. The device is supported by a shelf, for example, sitting on a lower supporting member of the shelf, such tat a thickness of the lower supporting member adds to the overall height occupied by the shelf-mounted device. One such unit is the TACLANE-MICRO KG-175D encryption device, available from General Dynamics, C4 Systems of Scottsdale, Ariz. Beneficially, the low-clearance, rack-mounting systems described herein accommodate rack mounting of such devices, while complying with standard rack unit measurements and without wasting valuable rack space. In at least some embodiments, such rack mounting can be accomplished without the need for tools.

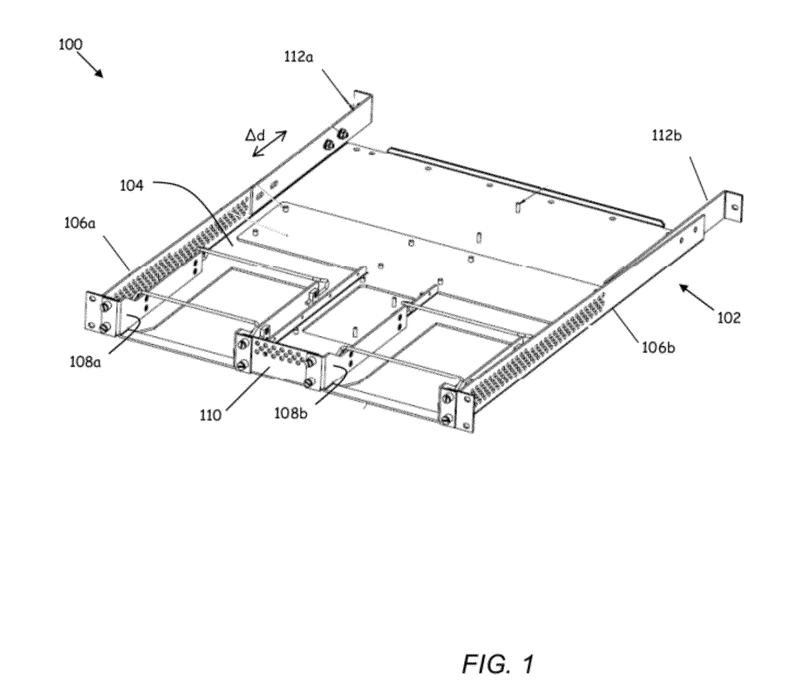

FIG. 1 illustrates an upper, front perspective view of an embodiment of a low-clearance, rack-mounting system 100. The system includes a rack-mountable shelf 102 including a lower, horizontal or tray support surface 104 extending substantially between left and right vertical side walls 106a, 106b (generally 106). The rack-mountable shelf 102 accommodates one or more device carrier chassis 108a, 108b (generally 108), that can be inserted from a front surface 110 of the shelf, as shown. The example system is configured to accommodate two modules (e.g., electronic modules), one within each of the device carrier chasses 108. Other configurations can accommodate one device or more than two devices in a similar fashion.

In at least some embodiments, the rack-mountable shelf 102 includes one or more support brackets 112a, 112b (generally 112). The support brackets 112 allow for fastening of a rear portion of the rack-mountable shelf 102 to an equipment rack support member (not shown), thus providing additional support. In the example embodiment, left and right support brackets 112 are fastened to the rack-mountable shelf 102, extending rearward to engage an equipment rack support member, such as left and right rear vertical frame members (not shown). Such support brackets 112 can be adjustable, as shown, to accommodate mounting within equipment racks of different depths. For example, the support brackets 112 can be attached to respective vertical side walls 106 through a multi-hole, and/or slotted hole-fastener arrangement, allowing for a travel distance Ad along a directed extending away from a front surface 110 of the shelf 102, thereby accommodating rear-supported mounting within equipment racks of various depths. In some embodiments, the support brackets 112 all for secure mounting of the shelf 102 within equipment racks having depths of, for example, 24 inches and 36 inches.

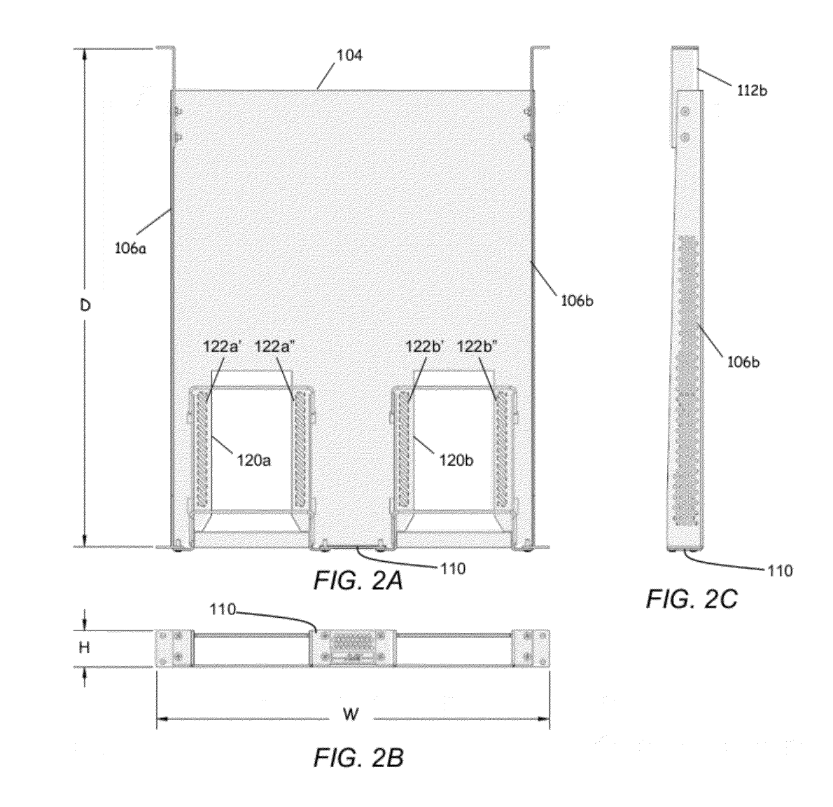

FIG. 2A through FIG. 2C respectively illustrate a top, front and side views of the rack-mounting system 100. In at least some embodiments, the lower tray support surface 104 includes at least one cutout to accommodate a portion of a device, when mounted therein. The lower tray or shelf support 104 of the example embodiment includes two such cutouts 120a, 120b (generally 120) to accommodate two electronic devices (not shown). The cutouts 120 are dimensioned such that at least a portion of the shelf support 104 remains to serve as a lower device support. In the example embodiment, two such support surfaces 119a′, 119a″ are provided for the first cutout 120a and two similar support surfaces 119b′, 119b″ are provided for the second cutout 120b. In the example embodiment, these surfaces, collectively 119, are located adjacent to one or more edges of the cutouts 120. In at least some embodiments, the device support surfaces 119 are relatively smooth and free of interference to accommodate slideable insertion and removal of devices from a front surface 110 of the rack-mountable shelf 102.

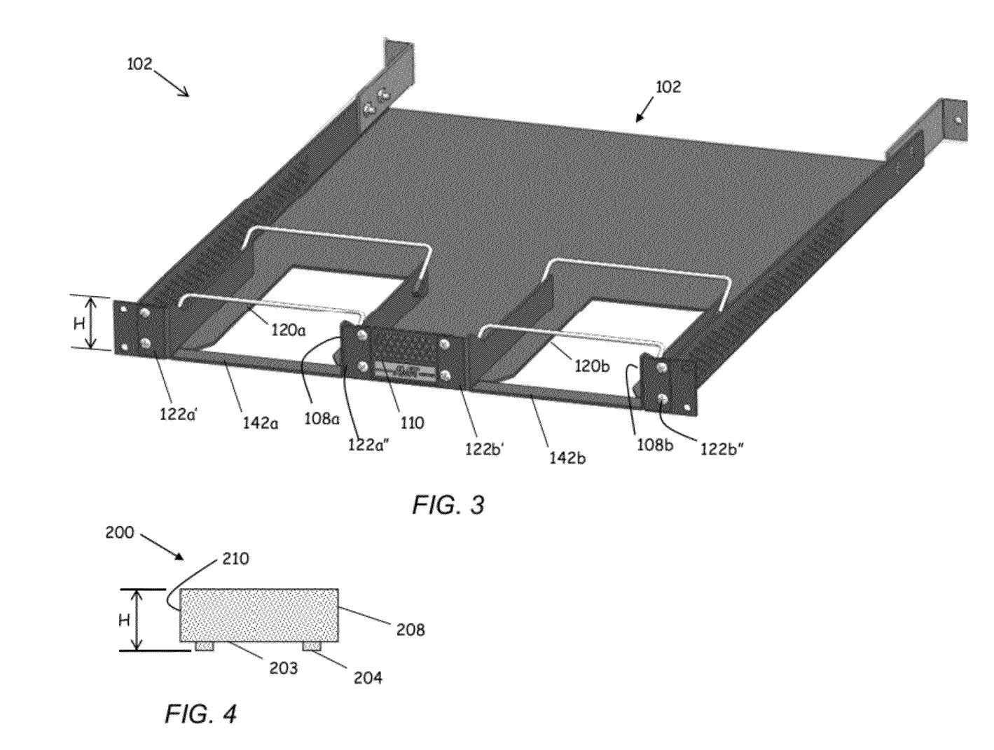

FIG. 3 illustrates an upper, front perspective view of the low-clearance, rack-mounting system 100. Two empty device carrier chasses 108a, 108b are shown mounted within the rack-mountable shelf 102. Each of the carrier chassis 108 includes mounting flanges 122a′, 122a″, 122b′, 122b″ (generally 122) configured for securing the carrier chassis 108 to the front panel 110 of the rack-mountable tray 102. Bottom edges 130′, 130″ of left and right vertical side walls of each device carrier chassis 108 rest along a top side of the horizontal surface 104 of the rack-mountable shelf 102. A vertical height ‘H’ of the low-clearance, rack-mounting system is illustrated. For example, the height H is 1U, including appropriate clearance (i.e., H=1.75 inches— 1/32 inch, or approximately 1.71 inches).

FIG. 4 illustrates a front view of an example of a standard-rack-height device 200 mountable by the low-clearance, rack-mounting system 100. In an illustrative example, the overall height of the device is also a standard 1U rack height, including some clearance (e.g., H=1.719 inches). In the illustrative example, the device 200 includes standoffs or feet 204 as in the TACLANE-MICRO KG-175D encryption device, presenting an additional challenge for shelf-mounting in a low-clearance application. Normally, the feet 204 would extend for some height below a bottom surface 203 of the device 200, such that the overall height H of the device, with feet would be greater than the height of a front panel 210 of the device 200. Beneficially, in the present rack mounting system 100, the cutouts 120 allow such feet 204 to extend below the horizontal surface of the shelf 104.

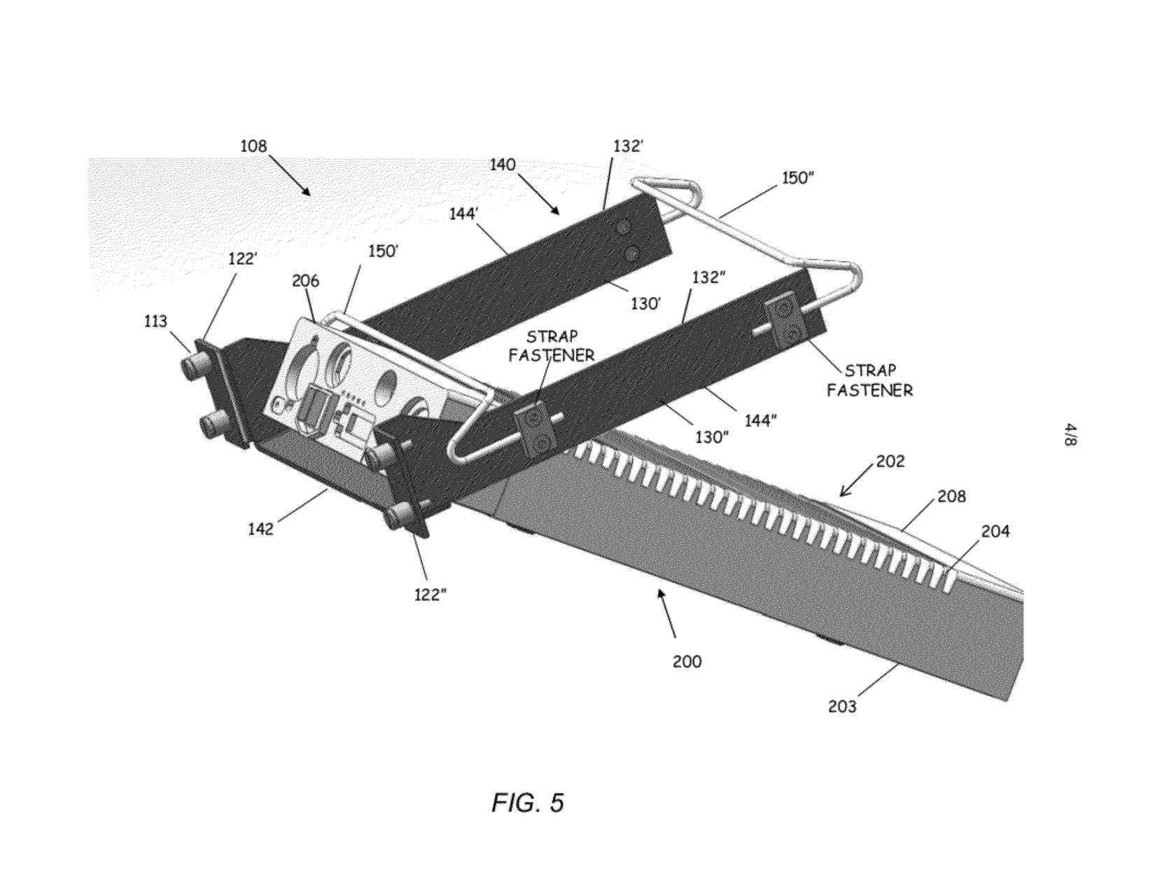

FIG. 5 illustrates a mounting process as used in the illustrative example of a standard-rack-height device 200 within the device carrier 108, which is mountable within an equipment rack by the low-clearance, rack-mounting system 100. The device carrier, or chassis 108 includes an open frame 140 having a lower horizontal support, or bar 142. The length of the bar 142 is sufficient to accommodate a width of a device 200, typically providing some clearance to facilitate mounting/dismounting of the device 200. The carrier chassis 108 also includes opposing left and right vertical side walls 144′, 144″ (generally 144). Forward portions of each of the left and right side 144 walls are fixedly attached at either end of the lower horizontal support bar 142. Also attached at forward portions of each of the side walls 144 are respective flanges 122′, 122″ configured to abut adjacent surfaces of a front panel 110 (e.g., FIG. 1) of the rack-mountable tray 102. In some embodiments, one or more of the side walls 144, horizontal support bar 142 and mounting flanges 122 are formed as a single unit, for example being bent or otherwise formed from a single piece of sheet metal. Alternatively or in addition, one or more components of the chassis 108, including the entire chassis itself 108, can be molded, or die cast. The chassis 108 can be made from similar or identical material as used for the rack-mountable tray 102. Such materials include steel. Other materials can be used, provided that they have substantial rigidity and strength to support a device 200 without otherwise deforming or breaking Such materials can include polymer based materials, such as plastics, and resin based materials, such as reinforced fiberglass, and more generally, composites, including fibers within a solid matrix, such as a resin.

The carrier chassis 108 also includes at least one device-mounting strap. The example embodiment includes two such straps: a forward mounting strap 150′ and a rear mounting strap 150″. The device-mounting straps 150′, 150″ (generally 150) extend between top edges 132′, 132″ (generally 132) of the left and right side walls 144, being securely attached at either end to the adjacent wall 144. Preferably, the device-mounting straps 150 are configured to engage a feature of the mounted device 200 to prevent forward and or rearward movement of the device 200 when mounted within the chassis 108.

In the example embodiment, a top surface 202 of the device 200 includes flutes or grooves 204. Such features 204 can be included in the top surface 202 of the device 200 for the particular purpose of engaging the device-mounting straps 150, or can be features 204 of opportunity as may be provided by a heat sink. In the example embodiment, each of the device-mounting straps 150 is sized, shaped and positioned to fit within a respective flute or groove 204, preferably without extending above a maximum height H of the device, such that the device-mounting straps 150 do not interfere with or bind when the chassis 108 and a mounted device 200 is slid into or removed from an opening in the front surface 110 of the shelf 102. In mounting, a front portion 206 of the device 200 is slid forward between the left and right side walls 144, until the front portion 206 is over the horizontal support bar 142 and substantially aligned with the left and right front mounting flanges 122. A rear portion 208 of the device 200 is initially positioned during mounting below rearward ends of the left and right side arms 144. The device can be approximately pivoted about the horizontal support bar 142 in a cantilever fashion, such that the rear portion 208 is rotated from a lower position, below bottom edges 130 of each sidewall 144, upward, toward the rear device-mounting strap 150″. Such pivoting continues until at least the rear device-mounting strap 150″ engages an adjacent flute or groove 204 on the device 200.

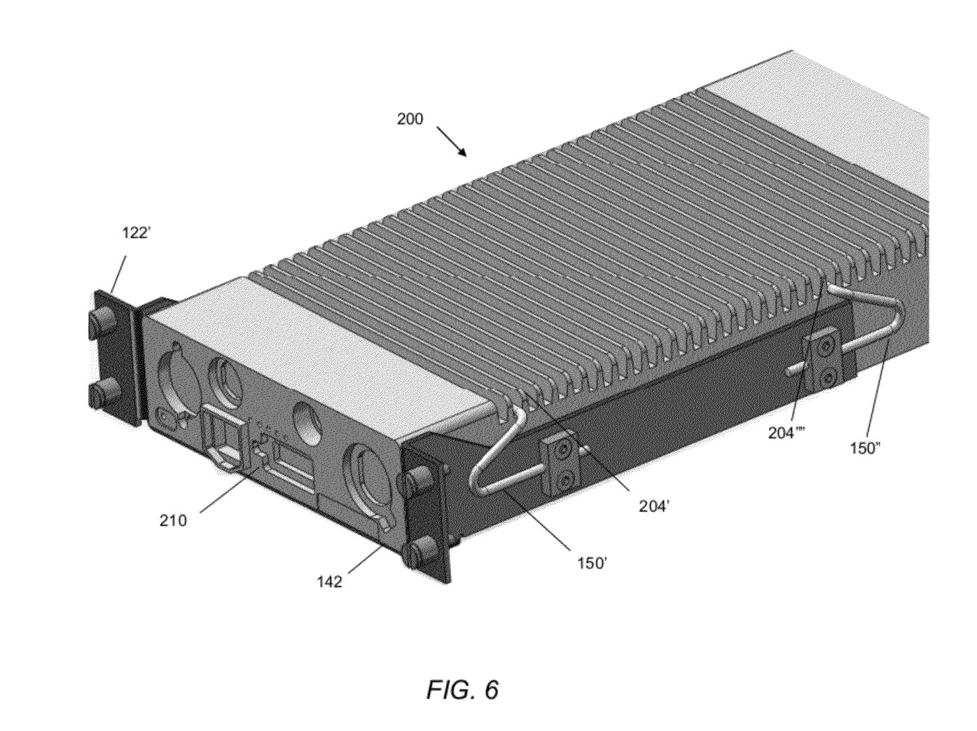

FIG. 6 illustrates an example of a standard-rack-height device 200 secured to an embodiment of a device carrier 108 mountable by a low-clearance, rack-mounting system. As illustrated each of the front and rear mounting straps 150′, 150″ is positioned within an adjacent groove 204′, 204″. When mounted in the example chassis 108, the front portion 206 of the device 200 rests upon the horizontal support bar 142. A front surface 210 of the device 200 can be substantially in the same plane as the support flanges 122, that abut a front surface 110 of the mounting shelf 102. In some embodiments, the device 200 can be accommodated or otherwise mounted in the chassis 108 such that the front surface 210 protrudes from or is recessed with respect to the front surface 110.

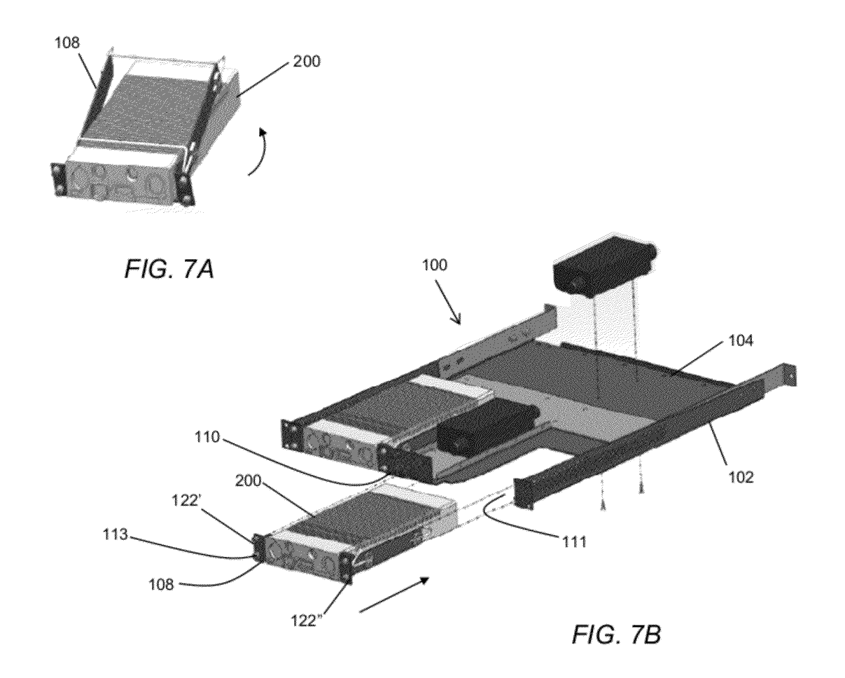

FIG. 7 illustrates cantilever mounting of an example of a standard-rack-height device 200 within an embodiment of a device carrier 108 mountable by a low-clearance, rack-mounting system 100, and insertion of the chassis-mounted device 200 into a low-clearance, rack-mounting shelf 102. Once the device 200 is secured within the device carrier 108, the device 200 and carrier 108 combination can be inserted into a respective opening 111 in the front panel 110 of the rack-mountable shelf 102. The device 200 and carrier 108 are inserted until rear-racing surfaces of the left and right front mounting flanges 122 of the carrier 108 abut front surfaces of the front panel 110 of the rack-mountable shelf 102. Fasteners, such as the thumbscrews 113 shown, can be provided to secure the carrier mounted device 200 with respect to the rack-mountable shelf 102. The rack-mountable shelf 102, in turn, can be inserted and secured to a standard equipment rack (not shown). Beneficially, insertion of the carrier-mounted device 200 can be accomplished before or after the rack-mountable shelf 102 has been secured within an equipment rack.

Thus, in mounting a device 200 in an example embodiment of a rack-mounting system 100, the device 200 is slid into the carrier 108 as illustrated in FIG. 7A. The front of the device is positioned to be flush with a front edge of the carrier 108. For example, the front panel 210 of the device, is substantially in the same plane as the front mounting flanges 122. The carrier 108 containing the mounted device 200 can be slid into an opening 111 in a front panel 110 of the rack-mountable shelf 102. The carrier 108 can be fastened to the shelf 102, for example, by securing the front flanges 122 to abutting portions of the front panel 110 of the shelf 102. Fasteners can be used to provide a securable attachment of the carrier 108 to the shelf 102. In at least some embodiments, the fasteners include thumb-screws, such that the entire mounting procedure of the device 200 to the carrier 108 and the carrier 108 to the shelf 102 can be accomplished without the need for tools.

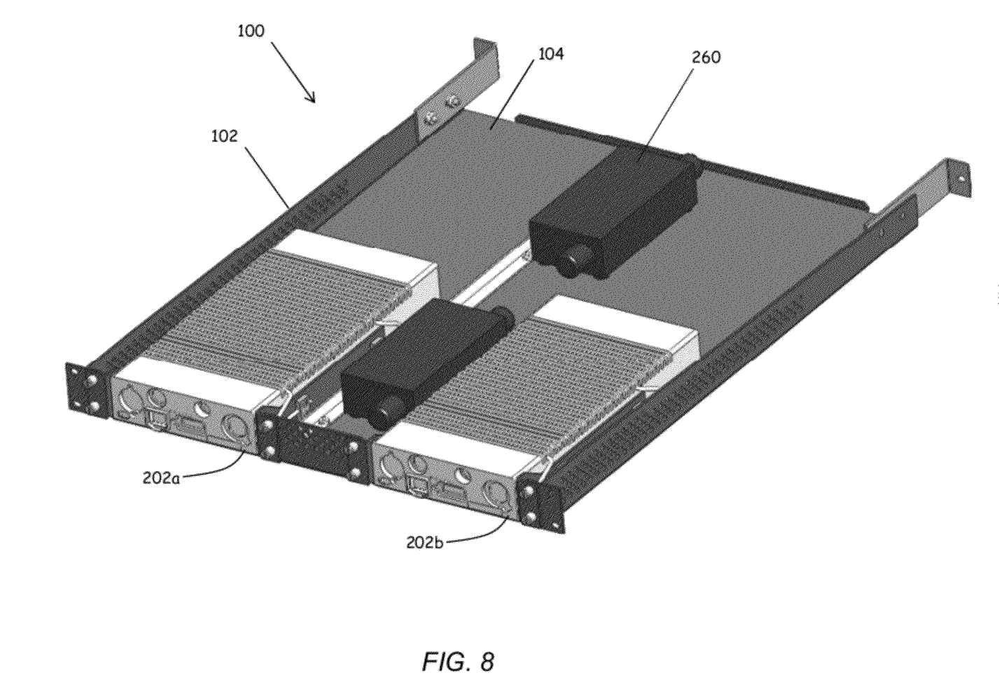

FIG. 8 illustrates an upper perspective view of two example standard-rack-height devices 200a, 200b flush mounted within a low-clearance, rack-mounting system 100. Also illustrated are ancillary equipment, such as power supplies 260 that can be positioned on, and in some instances secured to, the rack-mountable shelf 102.

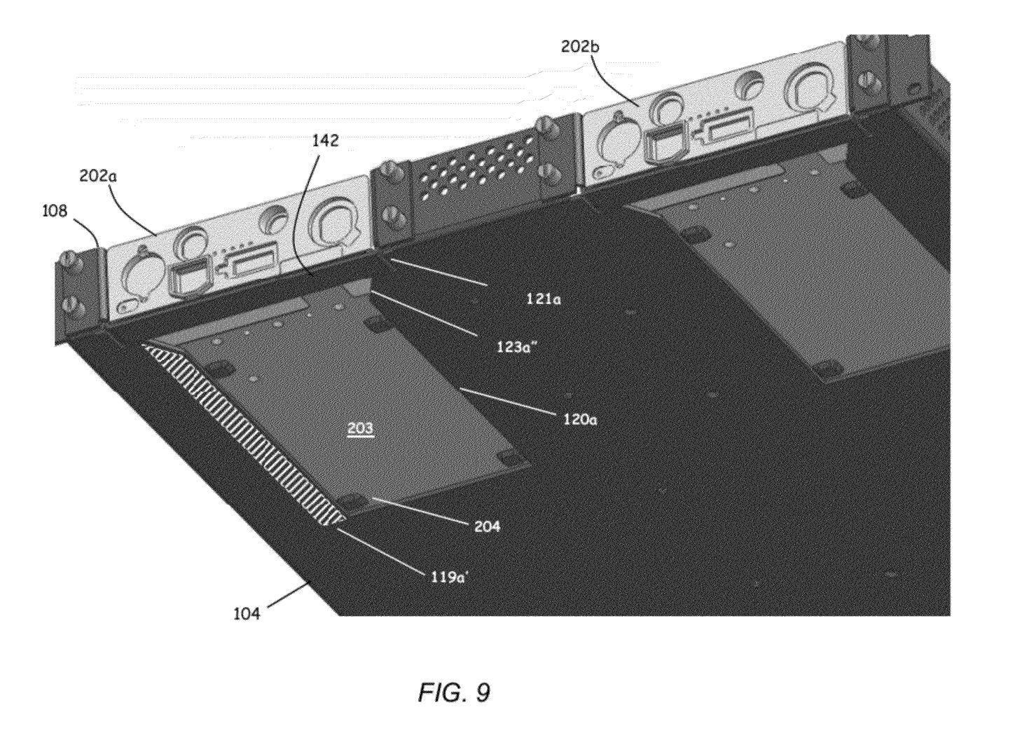

FIG. 9 illustrates a lower perspective view of a portion of the two example standard-rack-height devices 202a, 202b mounted within the low-clearance, rack-mounting system 100 illustrated in FIG. 8. In the illustrative embodiments, the cutout 120a is sized to accommodate the device standoffs or feet 204, allowing the feet 204 to extend below a top surface of the horizontal mounting shelf 104. In the illustrative embodiment, at least a portion of a lower surface 203 of the device 200 overlaps an adjacent portion of the horizontal mounting shelf 104. Such overlap 119a′ may extend along one or more edges of the tray cutout 120a. Advantageously, such overlap 119a′ prevents vertical movement and/or rotation of the device 200, thereby keeping the device 200 engaged with the one or more device mounting straps 150 (e.g., FIG. 6).

In at least some embodiments, a forward portion 121a of the cutout 120a is dimensioned to accommodate the horizontal support 142 of the device carrier 108 to efficiently conserve overall height. Namely, the depth of the horizontal support 142 does not add to an overall height of a chassis mounted device 200, as the height of the horizontal support 142 is allowed to extend below the top surface of the shelf 104, as accommodated by the forward portion 121a of the cutout 120a. Also shown is a tapered portion 123a″ extending between the forward portion 121a of the cutout 120a and the rest of the cutout 120a. The taper 123a″ can be configured to guide device standoffs or feet into the tray cutout.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A low-clearance rack mounting adapter comprising:
at least one device carrier comprising:
an open frame having a horizontal support and at least one tray mounting flange;
at least one device-mounting strap securably attached to the open frame, such that the at least one device-mounting strap and the horizontal support are configured to retain a device having a maximum height therebetween without substantially adding to the maximum height; and
a rack-mountable tray defining at least one aperture configured accommodate the at least one device carrier and having at least one surface to accommodate the at least one tray mounting flange,
wherein the rack-mountable tray secures the device carrier and device retained therein with respect to an equipment rack without substantially adding to the maximum height.

2. The rack mounting adapter of claim 1 further comprising at least one fastener adapted for securing the device carrier to the rack-mountable tray.

3. The rack mounting adapter of claim 1, wherein the at least one fastener comprises a thumbscrew adapted for fastening and unfastening without the aid of a tool.

4. The rack mounting adapter of claim 1, wherein a height of the device is

5. The rack mounting adapter of claim 1, wherein a device having a height measured by an integer number of standard rack units is mountable by the low-clearance rack mounting adapter occupying no more than the same integer number of standard rack units.

6. The rack mounting adapter of claim 1, wherein the rack-mountable tray defines at least one aperture configured to accommodate at least one protrusion extending away from a bottom surface of the device.

7. The rack mounting adapter of claim 1, wherein the open frame further comprises at least one device mounting strap extending between lateral sides of the open frame and adapted to engage an opposite side of the device as the horizontal support.

8. A method for securing a device within an equipment rack, comprising:
positioning the device within an open frame of a device carrier, the device having a maximum height;
securing the device with respect to the device carrier, a combined height of the device and the device carrier being substantially no greater than the maximum height of the device; and
securing the device carrier with the device secured thereto to a rack-mounted tray, a combined height of the device, the device carrier and the rack-mounted tray being substantially no greater than the maximum height of the device.

9. The method of claim 8, wherein positioning the device within an open frame of a device carrier comprises positioning a front surface of the device substantially flush with a front edge of the open frame of the device carrier, and pivoting with respect to the front surface, a rear end of the device into engagement with an abutting surface of the open frame of the device carrier.

10. The method of claim 8, further comprising sliding the device carrier into an opening of a front panel of the rack-mountable shelf, and fastening the device carrier to the rack mountable shelf

11. The method of claim 10, wherein fastening the device carrier to the rack mountable shelf comprises using fasteners.

12. The method of claim 11, wherein fastening is accomplished by hand, without a need for tools.

13. The method of claim 11, further comprising securing the rack-mounted tray containing the device and the device carrier to an equipment rack.

14. A low-clearance rack mounting adapter comprising:
means for positioning the device within an open frame of a device carrier, the device having a maximum height;
means for securing the device with respect to the device carrier, a combined height of the device and the device carrier being substantially no greater than the maximum height of the device; and
means for securing the device carrier with the device secured thereto to a rack-mounted tray, a combined height of the device, the device carrier and the rack-mounted tray being substantially no greater than the maximum height of the device.
